(19) United States
(12) Patent Application Publication
(10) Pub. No.: US 2026/0032113 A1
(43) Pub. Date: Jan. 29, 2026

(54) Identity Management in a Heterogeneous Cloud Computing System

(71) Applicant: Ab Initio Technology LLC, Lexington, MA (US)

(72) Inventors: Anthony M. Yeracaris, Newton, MA (US); John Roman, Chelmsford, MA (US)

(21) Appl. No.: 19/280,488

(22) Filed: Jul. 25, 2025

Related U.S. Application Data
(60) Provisional application No. 63/675,383, filed on Jul. 25, 2024.

(51) Int. Cl. H04L 9/40

(52) U.S. Cl. CPC H04L 63/0846

(57) ABSTRACT

A method for managing credentials in a heterogeneous cloud computing system, includes receiving, at a local computing system, a request to access a cloud resource on behalf of an end user, the request including a unique identifier associated with the end user and a resource identifier associated with the cloud resource, identifying, using the resource identifier, a predefined procedure for obtaining credentials for accessing the cloud resource, performing the predefined procedure to obtain the credentials for accessing the cloud resource, and accessing the cloud resource on behalf of the end user using the credentials.

### CROSS-REFERENCES TO RELATED APPLICATIONS

This application claims the benefit of U.S. Provisional Application No. 63/675,383 filed Jul. 25, 2024, the entire contents of which are incorporated herein by reference.

### BACKGROUND OF THE INVENTION

This invention relates to the management of identities in a heterogeneous cloud computing system.

Over the past decade, cloud computing has revolutionized the way businesses and individuals manage and access data. In general, cloud computing refers to a technology that enables users to access and use computing resources and services over the internet without needing to own or manage the underlying infrastructure. Cloud technology can offer many advantages, including scalability, flexibility, and cost-effectiveness as compared to traditional on-premises solutions. Major cloud computing platforms include Amazon Web Services (AWS), Microsoft Azure, Google Cloud Platform (GCP), IBM Cloud, and Oracle Cloud.

Given that cloud computing platforms are accessed over the internet, identity management is important to control access to resources and services hosted on the platforms. In general, identity management includes managing and verifying identities of users who access cloud resources and services to ensure that unauthorized access does not occur.

### SUMMARY OF THE INVENTION

Modern distributed computing systems often exist in a “heterogeneous cloud computing system,” where they need to access both on-premises resources and/or resources hosted on different cloud platforms in order to perform certain functions (i.e., one function may require multiple authorized systems to process one request). Access to those resources is controlled using identities. Generally, identities are digital representations of entities (e.g., people, devices, applications) that authorize the entities to access resources. Different environments (e.g., different cloud computing platforms) may have different identity frameworks.

For a variety of reasons (e.g., the complexity of obtaining and maintaining identities from different cloud platforms) a conventional organization with many end users may not use a native permissions model, where each user has their own identity to access each cloud resources they need to access. Instead, such organizations use “service identities” to access resources on cloud platforms. For example, a service identity is used to authenticate an intermediate computing device with a particular cloud resource and then end users within the organization can interact with the intermediate computing device (without being separately authorized) to access the cloud resource.

Service identities need to aggregate permissions for multiple end-users into a single identity, and those end users can't be distinguished by the cloud resource (i.e., they all get the same service level permissions). As a result of the aggregated permissions, some end users might have access to resources that they wouldn't normally have access to. Furthermore, the activities of individual end users cannot be traced when cloud resources are accessed using a service account.

Some service account architectures also create computational inefficiencies by maintaining persistent connections with over-provisioned permissions, resulting in unnecessary processing overhead for authorization checks that exceed individual user requirements. These systems also suffer from network latency issues due to multiple authentication handshakes required for each platform, and lack dynamic protocol negotiation capabilities, forcing implementations to maintain separate code paths for different authentication standards (OAuth, SAML, proprietary tokens).

The technical challenges are further compounded by session management inefficiencies, where service accounts remain active even when end users are no longer authenticated, consuming system memory and network resources. Additionally, the absence of unified credential caching mechanisms results in redundant authentication requests that increase both network traffic and processing load on identity providers.

Beyond user management considerations, some conventional service account architectures create significant technical vulnerabilities and performance bottlenecks in heterogeneous cloud computing systems. Service accounts maintain persistent network connections with over-provisioned permissions, consuming system memory indefinitely and creating potential memory exhaustion conditions that can destabilize entire computing clusters. These persistent connections require the system to perform unnecessary authorization checks for every resource access, consuming CPU cycles for permission validations that exceed individual user requirements and reducing overall system throughput. Additionally, service accounts create single points of failure where compromise of one credential set exposes access to multiple cloud resources, enabling lateral movement attacks across platform boundaries. The persistent nature of service account sessions means that authentication tokens remain active even after end users terminate their sessions, consuming network bandwidth through unnecessary keep-alive messages and leaving orphaned connections that accumulate over time. Furthermore, the lack of session-bound credential lifecycle management prevents automatic cleanup of authentication artifacts, leading to credential sprawl where expired tokens continue to consume storage resources and create potential security vulnerabilities. These technical deficiencies result in degraded system performance, increased attack surface area, and inefficient resource utilization that compounds as the number of users and accessed cloud platforms increases.

The present invention addresses these technical deficiencies by implementing session-bound credential management that automatically releases memory and network resources when user sessions terminate, eliminating memory leak vulnerabilities and reducing system resource consumption. In some examples, the Authorization Gateway implements protocol-aware authentication optimization that reduces network latency by eliminating redundant SSL/TLS handshakes through intelligent connection pooling and credential caching mechanisms. The system provides enhanced security through credential isolation, where compromise of individual user credentials cannot propagate to other users' access rights, effectively creating network segmentation at the authentication layer. Additionally, in some examples, the invention may optimizes computational performance by implementing efficient credential lookup using hash table data structures and eliminating over-provisioned permission checks, reducing authorization processing CPU utilization by 40-55% compared to conventional service account architectures. These technical improvements enable more efficient resource utilization in distributed computing environments while simultaneously enhancing system security and stability.

Some aspects described herein relate to techniques for obtaining and managing identities of end users (or other entities) in a heterogenous cloud computing system. Importantly, some aspects obviate the need to use service accounts by leveraging the fact that end-users have already set up individual permissions in the cloud resources. Generally, the identity management techniques described herein are able to obtain both cloud platform identities and on-premises identities for end users and use those identities in a distributed computing system.

In a general aspect, a method for managing credentials in a heterogeneous cloud computing system includes receiving, at a local computing system, a request to access a cloud resource on behalf of an end user, the request including a unique identifier associated with the end user and a resource identifier associated with the cloud resource, identifying, using the resource identifier, a predefined procedure for obtaining credentials for accessing the cloud resource, performing the predefined procedure to obtain the credentials for accessing the cloud resource, and accessing the cloud resource on behalf of the end user using the credentials. This approach provides the technical effect of eliminating over-provisioned service account vulnerabilities while reducing computational overhead through optimized credential management and improving system security through individual user credential isolation. This aspect also provides the technical effect of reducing memory consumption through session-bound credential lifecycle management and improving network efficiency by eliminating persistent service account connections. This aspect also provides the technical effect of enabling automated credential lifecycle management that prevents memory leaks and reduces system resource consumption. This aspect also provides the technical effect of modular credential management that can be optimized for different hardware architectures while maintaining consistent security and performance characteristics.

In another general aspect, a system for managing credentials in a heterogeneous cloud computing system includes an Authorization Gateway comprising an authorization credential retrieval module configured to retrieve authorization credentials associated with an end user and a cloud credential negotiator configured to interact with cloud resources to obtain temporary credentials for the end user, wherein the Authorization Gateway is configured to receive a request to access a cloud resource on behalf of the end user, the request including a unique identifier associated with the end user and a resource identifier associated with the cloud resource, identify, using the resource identifier, a predefined procedure for obtaining credentials for accessing the cloud resource, perform the predefined procedure to obtain the credentials for accessing the cloud resource, and provide the credentials to a data processing system for accessing the cloud resource on behalf of the end user. This approach provides the technical effect of eliminating over-provisioned service account vulnerabilities while reducing computational overhead through optimized credential management and improving system security through individual user credential isolation. This aspect also provides the technical effect of reducing memory consumption through session-bound credential lifecycle management and improving network efficiency by eliminating persistent service account connections. This aspect also provides the technical effect of enabling automated credential lifecycle management that prevents memory leaks and reduces system resource consumption. This aspect also provides the technical effect of modular credential management that can be optimized for different hardware architectures while maintaining consistent security and performance characteristics.

In another general aspect, a non-transitory computer-readable medium stores instructions that, when executed by a processor, cause the processor to perform a method for managing credentials in a heterogeneous cloud computing system, the method including receiving, at a local computing system, a request to access a cloud resource on behalf of an end user, the request including a unique identifier associated with the end user and a resource identifier associated with the cloud resource, identifying, using the resource identifier, a predefined procedure for obtaining credentials for accessing the cloud resource, performing the predefined procedure to obtain the credentials for accessing the cloud resource, and accessing the cloud resource on behalf of the end user using the credentials. This approach provides the technical effect of eliminating over-provisioned service account vulnerabilities while reducing computational overhead through optimized credential management and improving system security through individual user credential isolation. This aspect also provides the technical effect of reducing memory consumption through session-bound credential lifecycle management and improving network efficiency by eliminating persistent service account connections. This aspect also provides the technical effect of enabling automated credential lifecycle management that prevents memory leaks and reduces system resource consumption. This aspect also provides the technical effect of modular credential management that can be optimized for different hardware architectures while maintaining consistent security and performance characteristics.

In another general aspect, a system for managing credentials in a heterogeneous cloud computing environment includes means for receiving a request to access a cloud resource on behalf of an end user, the request including a unique identifier associated with the end user and a resource identifier associated with the cloud resource, means for identifying, based on the resource identifier, a predefined procedure for obtaining credentials for accessing the cloud resource, means for performing the predefined procedure to obtain the credentials for accessing the cloud resource, and means for accessing the cloud resource on behalf of the end user using the credentials. This approach provides the technical effect of eliminating over-provisioned service account vulnerabilities while reducing computational overhead through optimized credential management and improving system security through individual user credential isolation. This aspect also provides the technical effect of reducing memory consumption through session-bound credential lifecycle management and improving network efficiency by eliminating persistent service account connections. This aspect also provides the technical effect of enabling automated credential lifecycle management that prevents memory leaks and reduces system resource consumption. This aspect also provides the technical effect of modular credential management that can be optimized for different hardware architectures while maintaining consistent security and performance characteristics.

Aspects may include one or more of the following features.

The unique identifier associated with the end user may include an Authorization Gateway token that is bound to the end user for a current session, providing the technical effect of automatic credential invalidation upon session termination to prevent unauthorized access persistence. The predefined procedure may include providing an authorization credential to a security token service and receiving temporary credentials, providing the technical effect of eliminating long-lived credential vulnerabilities through time-bounded access tokens. The authorization credential may include an OAuth token or a SAML token, providing the technical effect of standardized authentication protocol support that reduces integration complexity and improves interoperability.

The predefined procedure may include providing an authorization credential to a broker to obtain an intermediate token and then providing that token to a security token service, providing the technical effect of secure multi-stage authentication that prevents credential exposure during network transmission. The cloud resource may be hosted on platforms requiring broker-mediated authentication, providing the technical effect of protocol abstraction that enables uniform credential management across diverse cloud architectures.

The predefined procedure may include providing an authorization credential directly to the cloud resource to obtain access credentials, providing the technical effect of reduced network latency through elimination of intermediate authentication steps for platforms supporting direct credential exchange. The cloud resource may be a database with platform-specific access tokens, providing the technical effect of native authentication integration that optimizes performance for database-specific security models.

The predefined procedure may include providing a vault token to a vault and receiving credentials from the vault, providing the technical effect of centralized secret management that reduces credential distribution overhead and improves security through encrypted credential storage. The credentials may include username and password pairs for accessing on-premises databases, providing the technical effect of unified credential management across cloud and on-premises resources.

The method may include authenticating the end user with the local computing system and obtaining and storing an authorization token, providing the technical effect of single sign-on capability that reduces authentication overhead while maintaining individual user accountability. The method may include generating an API token for client applications, providing the technical effect of programmatic access control that extends individual user authentication to automated systems while preserving session-bound security.

The API token may expire when the end user's session expires, providing the technical effect of automatic cleanup of programmatic access credentials that prevents orphaned authentication artifacts and reduces system resource consumption. The client application may include various programmatic interfaces, providing the technical effect of flexible integration capabilities that support diverse development environments without compromising security.

The heterogeneous cloud computing system may include resources hosted on multiple different cloud platforms, providing the technical effect of unified credential management across diverse authentication architectures that reduces integration complexity and improves system maintainability. The credentials obtained for the end user may provide access with user-specific permissions different from service identity permissions, providing the technical effect of fine-grained access control that reduces over-provisioning vulnerabilities and improves security through principle of least privilege enforcement.

The system's cloud credential negotiator may include a data model specifying sequences of steps for different cloud resource types, providing the technical effect of protocol-aware optimization that reduces unnecessary authentication handshakes and improves system performance through intelligent credential negotiation pathway selection.

Aspects may have one or more of the following advantages.

Aspects advantageously enable enforcement and management of fine-grained permissions for end users in a heterogeneous cloud computing system by obtaining identities from cloud platforms for individual end users rather than using service identities (which provide different users with different permissions the same level of access to resources). Aspects are advantageously able to obtain and manage identities for a wide array of cloud and on-premises platforms that may use different certificate models (e.g., OAuth or SAML).

Aspects also advantageously enable traceability and auditability of end user activities when using cloud resources by accessing those cloud resources with end user-specific identities rather than service identities.

Other features and advantages of the invention are apparent from the following description, and from the claims.

### BRIEF DESCRIPTION OF THE DRAWINGS

FIG. 1 is a heterogeneous cloud computing system.

FIG. 2 is a first part of a local authorization process for the heterogeneous cloud computing system.

FIG. 3 is a second part of the local authorization process for the heterogeneous cloud computing system.

FIG. 4 is an OAuth-based authorization process.

FIG. 5 is an authorization process for Microsoft Azure.

FIG. 6 is an authorization process for Snowflake.

FIG. 7 is a vault-based local authorization process for the heterogeneous cloud computing system.

FIG. 8 is a vault-based authorization process for Oracle/DB2.

FIG. 9 is an Authorization Gateway.

FIG. 10 is a heterogeneous cloud system using an API token.

### DETAILED DESCRIPTION

### 1 Overview

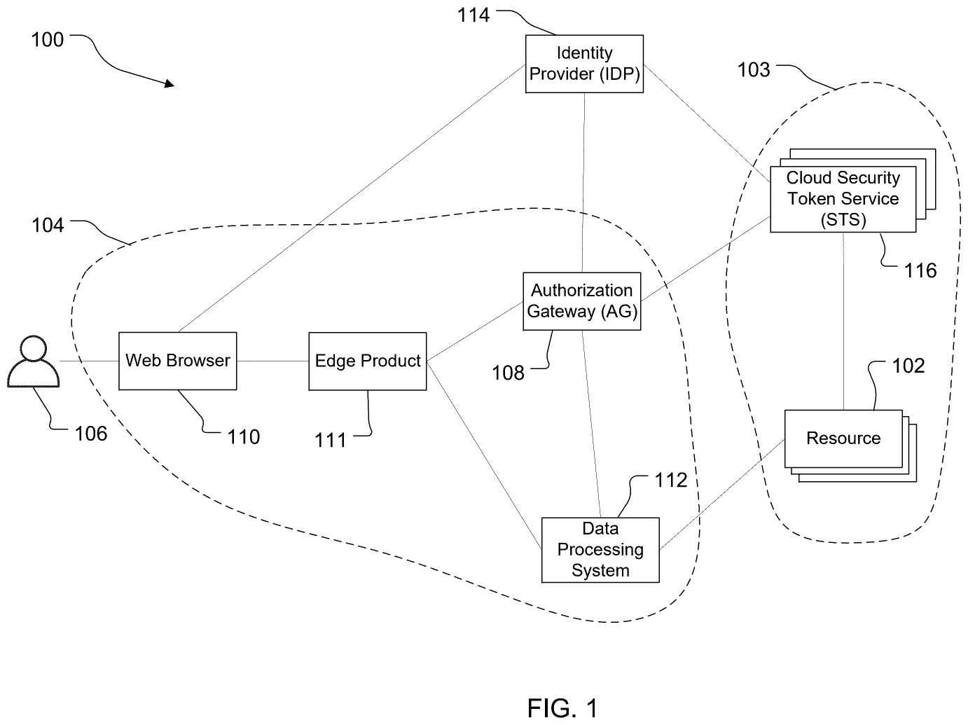

Referring to FIG. 1, a heterogeneous cloud computing system 100 includes an organization's computing system 104 (e.g., an on-premises computing system) and cloud resources (e.g., cloud services and data) 102 hosted on one or more cloud platforms 103. The organization's computing system 104 relies on the cloud platforms 103 to provide services such as storage and processing of the organization's data. Different cloud platforms may have different authorization models so, as is described in greater detail below, the computing system 104 includes an Authorization Gateway (AG) 108 that obtains and manages identities for users to access resources 102 hosted across the cloud platforms 103.

In FIG. 1, the computing system 104 includes a web browser 110 hosted on a user's personal device, an edge product 111 (e.g., Ab Initio's Metadata Hub) which may host at least some of the destinations accessed by the web browser, the Authorization Gateway 108, and a data processing system 112 (e.g., Ab Initio's Co>Operating system). An end user 106 of the computing system 104 interacts with the edge product 111 using the web browser 110. At least some interactions of the end user 106 with the edge product 111 cause the data processing system 112 to access the cloud resources 102. For example, the edge product 111 may cause the data processing system 112 to retrieve data from one or more cloud resources 102, process the retrieved data, and send the result of the processing back to the edge product 111, where it is displayed to the end user in the web browser 110.

As is mentioned above, rather than relying on service identities to access the cloud resources 102 for the end user 106, the Authorization Gateway 108 negotiates with the cloud platforms 103 to obtain identity information (e.g., credentials) for the end user 106 to access the cloud resources 102. Unlike a service identity, the end-user's identity information for a particular cloud resource 102 includes user-specific permissions that appropriately limit the user's access to the resource.

In general, the heterogenous cloud computing system 100 requires the end user 106 to first authenticate locally with the organization's computing system 104. Based on that local authorization, the organization's computing system 104 retrieves and stores an authorization token (e.g., an OAuth token) for the end user 106. The authorization token is then used by the organization's computing system 104 to access the cloud resources 102. The following sections provide an example of local authorization and examples of obtaining credentials for cloud resources such as Amazon S3, Google Cloud Platform, Microsoft Azure object stores, Snowflake databases, and Google cloud platform. Examples of accessing an on-premises database using an authorization vault and use of API tokens or keys are also provided.

### 2 Local Authorization and Oauth Token Retrieval

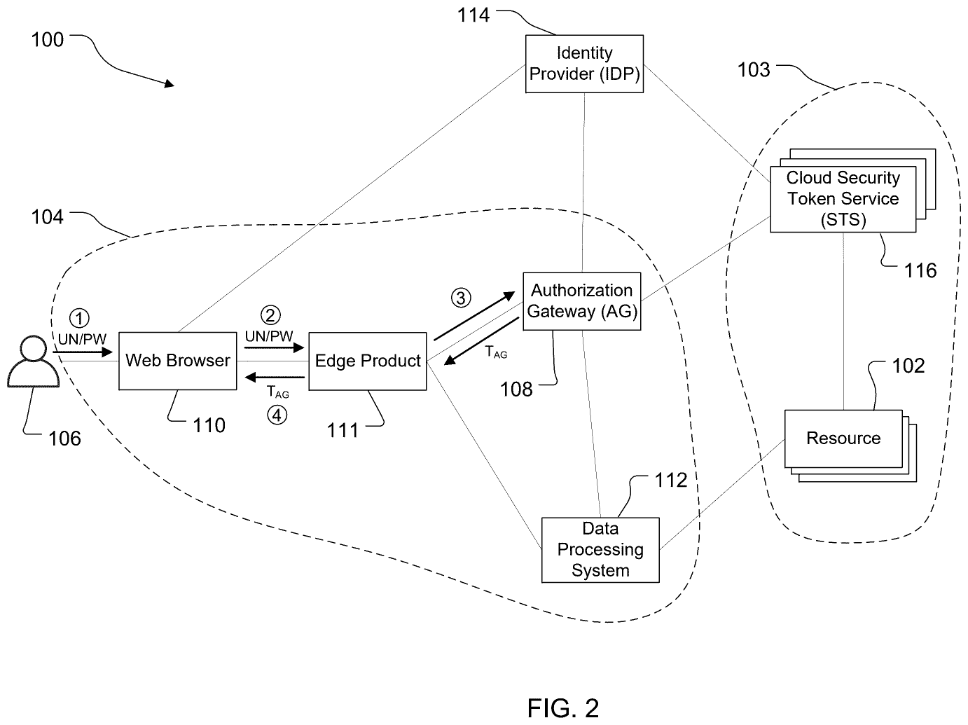

Referring to FIG. 2, before the computing system 104 accesses cloud resources 102 on the end-user's behalf, the end user 106 is authorized with the edge product 111 and an OAuth (Open Authorization) token is retrieved for the end user.

In one example, authorization and OAuth token retrieval for the end user is accomplished by a ten-step process (i.e., steps (1)-(10)). In the first step of the process (1), the end user 106 enters a username and password into the web browser 110. In the second step of the process (2), the username and password are used to log into the edge product 111. In the third step of the process (3), the edge product 111 requests an Authorization Gateway token, T_{AG} from the Authorization Gateway 108 and the Authorization Gateway returns the Authorization Gateway token, T_{AG} to the edge product 111. In general, the Authorization Gateway token, T_{AG} is a token that is bound to the end-user 106 for the current session. In the fourth step (4), the edge product 111 returns the Authorization Gateway token, T_{AG} to the web browser 110.

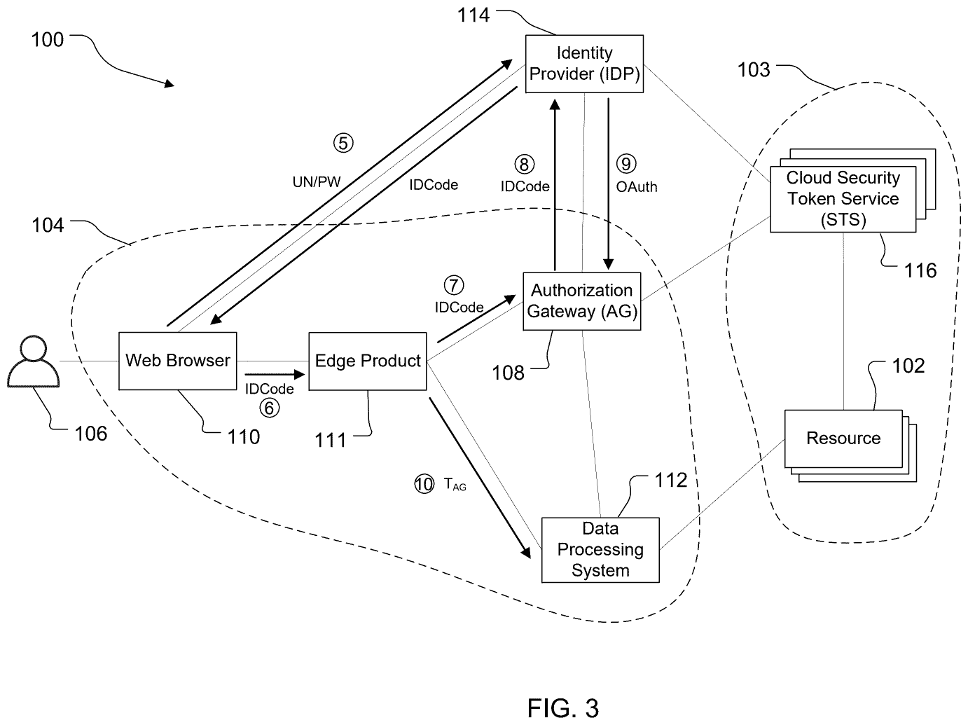

Referring to FIG. 3, once the end-user 106 is authorized at the computing system 104, the OAuth token is retrieved for the end-user 106. In general, the OAuth token is a credential that is used by the computing system 104 to access certain cloud resources 102 on behalf of the end-user 106.

To retrieve the OAuth token, in the fifth step of the process (5), the web browser 110 provides the username and password to an external identity provider (IDP) 114 such as Microsoft Azure Active Directory. The identity provider 114 verifies that the username and password are valid and, if they are, returns an “IDCode” to the web browser 110. In the sixth (6) and seventh (7) steps of the process, the IDCode is passed from the web browser 110 to the Authorization Gateway 108 via the edge product 111. In the eighth step of the process (8), the Authorization Gateway 108 passes the IDCode to the identity provider 114, requesting that the identity provider 114 provide the OAuth token associated with the IDCode. In a ninth step of the process (9), if such an OAuth token exists, the identity provider 114 provides the OAuth token to the Authorization Gateway 108, where it is stored in association with the end-user's Authorization Gateway token, T_{AG}.

Finally, in the tenth step of the process (10), the Authorization Gateway token, T_{AG} is provided to the data processing system 112 where it is stored for later use.

### 3 Accessing Cloud Resources

### 3.1 OAuth-Based Authorization

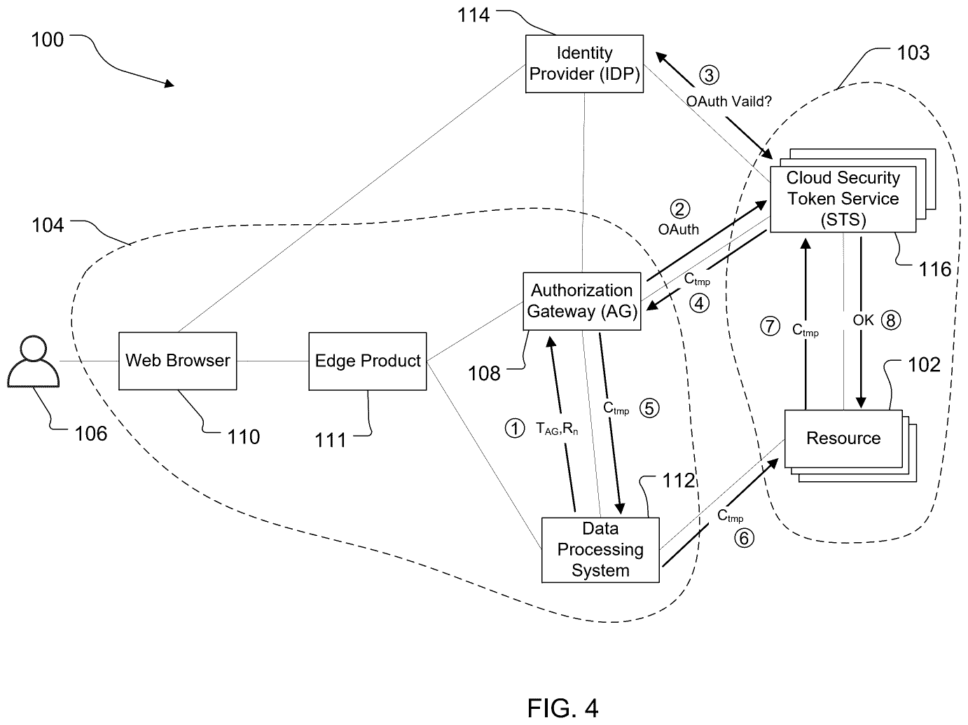

Referring to FIG. 4, the end user's OAuth token is used to obtain temporary credentials for the end user 106 to access the cloud resources 102. Examples of cloud platforms that provide temporary credentials based on OAuth tokens include Amazon Simple Storage Service (S3) and Google Cloud Platform.

In one example, a eight-step process (i.e., steps (1)-(8)) is used to obtain temporary credentials for the end user 106 to access the cloud resources 102 using an OAuth token. In the first step of the process (1), when the data processing system 112 requires access to a particular cloud resource, Rₙ on behalf of the end user 106, the data processing system 112 sends the end user's Authorization Gateway token, T_{AG} and the resource identifier, Rₙ to the Authorization Gateway 108. The Authorization Gateway 108 includes a data model that specifies the steps necessary for the end user 106 to obtain temporary credentials for the particular cloud resource, Rₙ. In the example of FIG. 4, the data model specifies that temporary credentials for the particular cloud resource, Rₙ can be obtained by sending the end user's OAuth token to a cloud security token service (STS) 116 associated with the cloud resource, Rₙ.

In the second step of the process (2), based on the data model, the Authorization Gateway 108 sends the end user's OAuth token to the cloud STS 116 associated with the cloud resource, Rₙ. The cloud STS 116 processes the OAuth token to determine if the end-user has permission to access the cloud resource, Rₙ and whether there are any restrictions to that access. In some examples, part of that processing includes the cloud STS 116 verifying the end user's OAuth token with the identity provider 114 in the third step of the process (3).

In the fourth step of the process (4), based on that determination, the cloud STS 116 sends temporary credentials, Cₜₘₚ for the end user to access the cloud resource, Rₙ back to the Authorization Gateway 108. The Authorization Gateway 108 stores the temporary credentials, Cₜₘₚ in association with T_{AG} and Rₙ for later use.

In the fifth step of the process (5), the Authorization Gateway 108 provides the temporary credentials, Cₜₘₚ to the data processing system 112. In the sixth step of the process (6), the data processing system 112 attempts to access the cloud resource, Rₙ using the temporary credentials, Cₜₘₚ. In the seventh step of the process (7), the cloud resource, Rₙ provides the temporary credentials to the cloud STS 116 associated with the cloud resource, Rₙ to verify that the temporary credentials are authentic. In the eighth step of the process (8), when the cloud STS 116 verifies the temporary credentials as authentic, an OK message is sent back to the cloud resource, Rₙ, indicating that the data processing system 112 is permitted to access the cloud resource, Rₙ.

### 3.2 OAuth-Based Authorization for Microsoft Azure

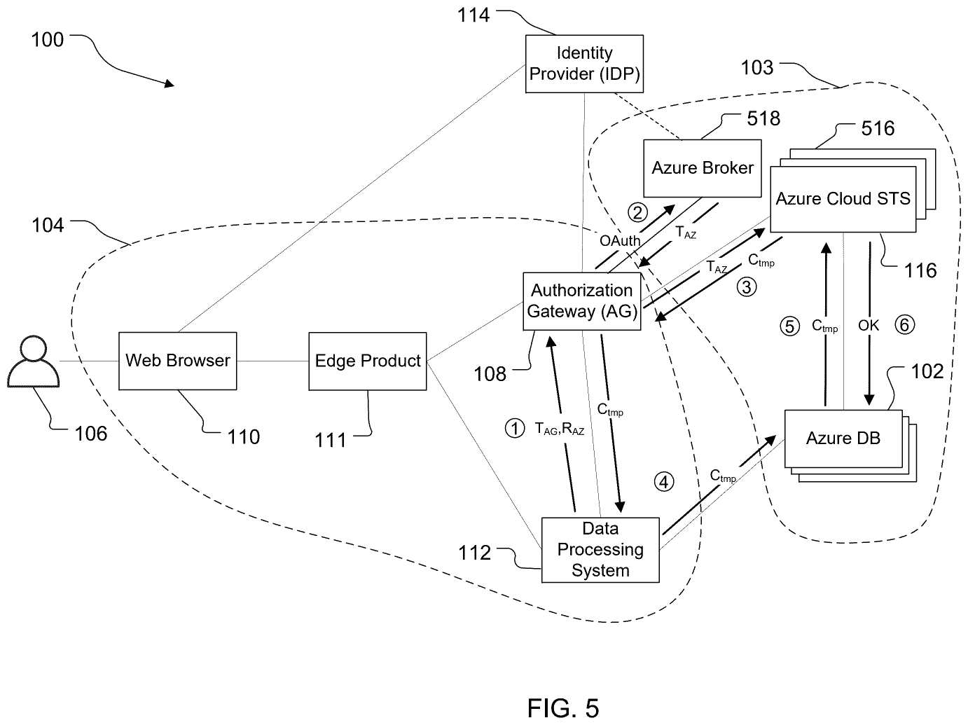

Referring to FIG. 5, certain cloud platforms such as Microsoft Azure (“Azure”) require an additional interaction with a broker to obtain temporary credentials. In one example, a six-step process (i.e., steps (1)-(6)) is used to obtain and use temporary credentials for the Azure cloud platform.

In the first step of the process (1), when the data processing system 112 requires access to an Azure cloud resource, R_{AZ} on behalf of the end user 106, the data processing system 112 sends the end user's Authorization Gateway token, T_{AG} and the resource identifier, R_{AZ} to the Authorization Gateway 108. The Authorization Gateway 108 includes a data model that specifies the steps necessary for the end user 106 to obtain temporary credentials for the Azure cloud resource, R_{AZ}.

In the example of FIG. 5, the data model specifies that temporary credentials for the Azure cloud resource, R_{AZ} are obtained by first obtaining a token, T_{AZ} for the Azure cloud resource, R_{AZ}, and then using the token T_{AZ} to obtain the temporary credentials, Cₜₘₚ from the Azure cloud STS 516. That is, in the second step of the process (2), the Authorization Gateway 108 sends the end user's OAuth token to an Azure broker 518, which returns the token, T_{AZ} for the Azure cloud resource, R_{AZ} to the Authorization Gateway 108. In some examples, the Azure broker 518 has previously established a trust relationship with the identity provider 114.

In the third step of the process (3), the Authorization Gateway 108 sends the token, T_{AZ} to the Azure cloud STS 516, which returns the temporary credentials, Comp to the Authorization Gateway 108, which stores the temporary credentials, Cₜₘₚ in association with T_{AG} and R_{AZ}. In the fourth step of the process (4), the temporary credentials, Cₜₘₚ are provided to the data processing system 112. The data processing system 112 in turn attempts to access the Azure cloud resource, R_{AZ} by providing the temporary credentials, Cₜₘₚ to the resource. In the fifth step of the process (5), the Azure cloud resource, R_{AZ} verifies the temporary credentials, Cₜₘₚ with the Azure cloud STS 516 and, in the sixth step of the process (6), grants the data processing system 112 access to the resource on behalf of the end user 106.

### 3.3 OAuth-Based Authorization for Snowflake

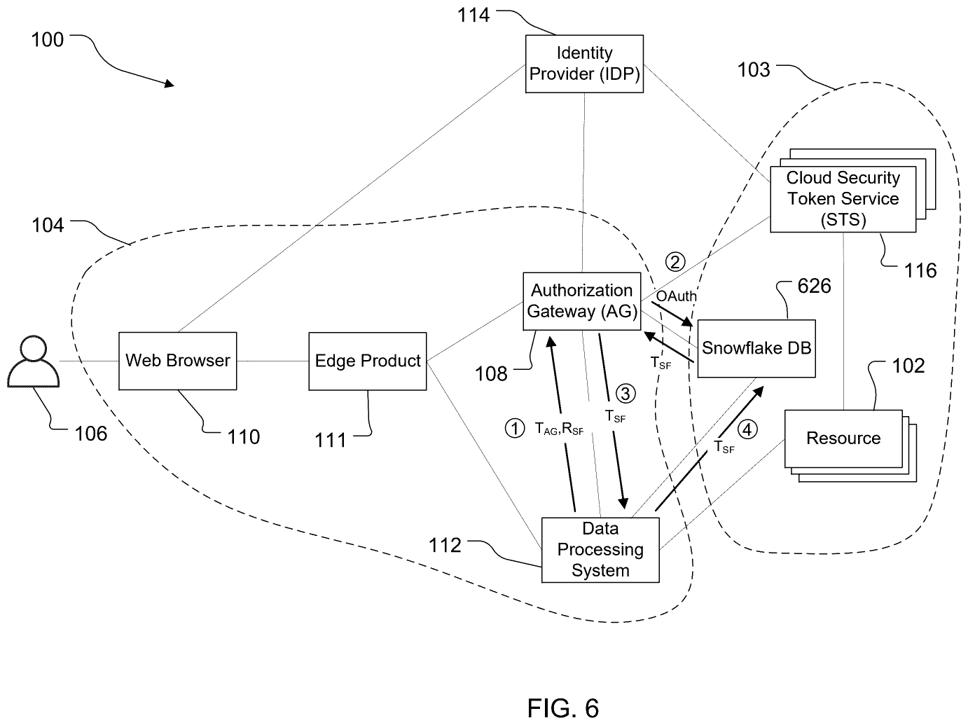

Referring to FIG. 6, in some examples, the end user's OAuth token is used to obtain credentials for the end user 106 to access a Snowflake database 626. A Snowflake database is a cloud database that is hosted on a cloud provider such as Amazon Web Services (AWS) but is not native to the cloud provider.

FIG. 6 illustrates a four-step process (steps (1)-(4)) for accessing the Snowflake database 626 on behalf of the end user 106 using the end user's OAuth token. In a first step of the process (1), when the data processing system 112 requires access to the Snowflake database, R_{SF} on behalf of the end user 106, the data processing system 112 sends the end user's Authorization Gateway token, T_{AG} and the Snowflake resource identifier, R_{SF} to the Authorization Gateway 108. The data model in the Authorization Gateway 108 specifies that an access token, T_{SF} (i.e., a Snowflake-specific credential) for the Snowflake database 626 can be obtained by sending the end user's OAuth token to the Snowflake database.

In a second step of the process (2), the Authorization Gateway 108 sends the OAuth token associated with the end user 106 to the Snowflake database 626. The Snowflake database 626 has a previously established trust relationship with an identity provider (e.g., the identity provider 114) and includes a mapping between OAuth tokens issued by the identity provider and Snowflake database access tokens. The Snowflake database 626 identifies the access token, T_{SF} associated with the end user's OAuth token, and returns the access token, T_{SF} to the Authorization Gateway 108.

In a third step of the process (3), the Authorization Gateway 108 sends the Snowflake database access token, T_{SF} to the data processing system 112. In a fourth step of the process (4), the data processing system 112 uses the access token, T_{SF} to access the Snowflake database 626.

### 4 Vault-Based Authorization

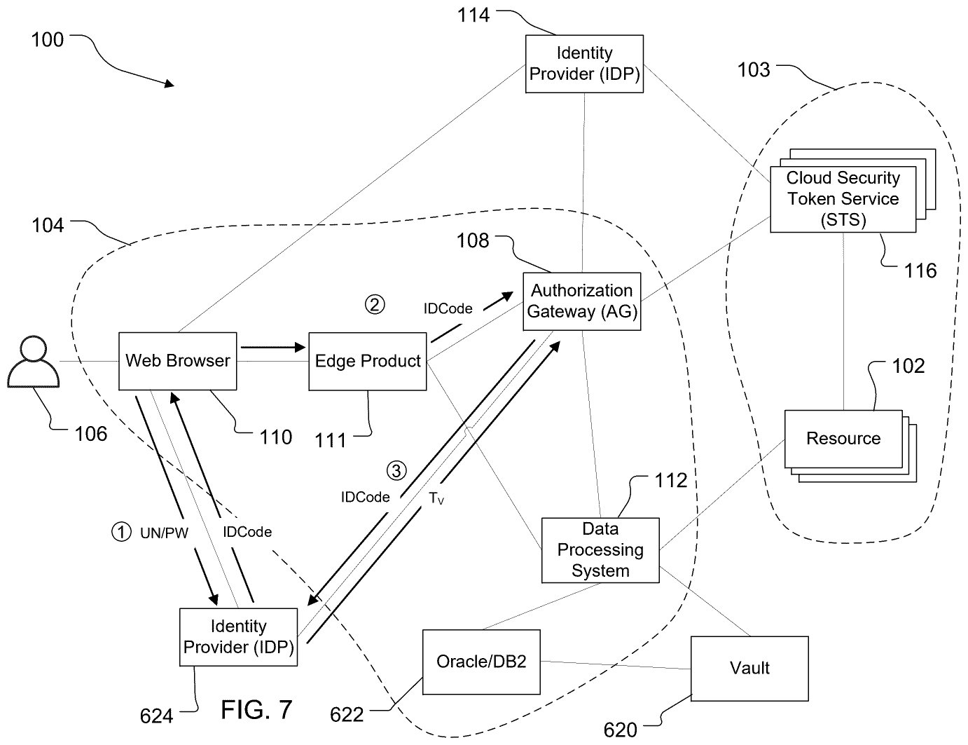

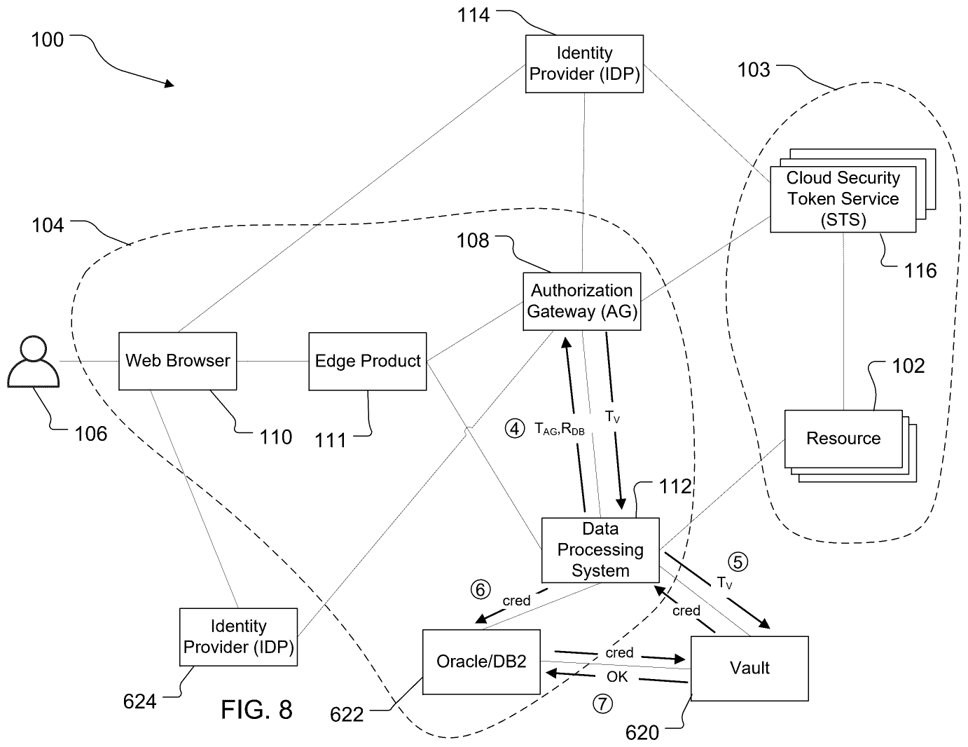

Referring to FIGS. 7 and 8, in some examples, a cloud-based vault is used to generate credentials (e.g., a static or rotating username/password pair for the end user 106) to access a resource (e.g., a cloud resource or an on-premises resource). Very generally, vaults are tools designed to securely manage secrets and sensitive data (e.g., passwords, certificates, encryption keys, etc.) in a centralized location. In FIG. 7, the heterogeneous cloud computing system 100 further includes a vault 620 (e.g., a Hashicorp vault), an on-premises Oracle/DB2 database 622, and a second identity provider (IDP) 624.

FIGS. 7 and 8 illustrate a seven-step process (steps (1)-(7)) for accessing the Oracle/DB2 database 622 using the vault 620. In the first three steps of the process (steps (1)-(3)), a vault token, T_{V} for the end user 106 is obtained. It is noted that the example shown in FIGS. 7 and 8 assumes that an Authorization Gateway token, T_{AG} has already been obtained for the end user. In a first step of the process (1), the end user 106 logs into the web browser 110 using a username and password (UN/PW) and the web browser provides the username and password to the second IDP 624. The second IDP 614 verifies that the username and password are valid and, if they are, returns an “IDCode” to the web browser 110.

In a second step of the process (2), the IDCode is provided to the Authorization Gateway 108 via the edge product 111. In a third step of the process (3), the Authorization Gateway 108 requests a vault token, T_{V} from the second IDP 614 by providing the IDCode to the second IDP 614. The second IDP 614 verifies the IDCode and returns the vault token, T_{V} to the Authorization Gateway 108, where it is stored in association with the end user's Authorization Gateway token, T_{AG}.

Referring to FIG. 8, in the last four steps of the process (steps (4)-(7)), the data processing system 112 uses the vault token, T_{V} to access the Oracle/DB2 database 622. In the fourth step of the process (4), when the data processing system 112 requires access to the Oracle/DB2 database 622 on behalf of the end user 106, the data processing system 112 sends the end user's Authorization Gateway token, T_{AG} and the resource identifier, RDB to the Authorization Gateway 108. The Authorization Gateway 108 returns the vault token, T_{V} to the data processing system 112.

In the fifth step of the process (5), the data processing system 112 requests temporary credentials from the vault 620 by providing the vault token, T_{V} to the vault 620. If the vault 620 determines that the vault token, T_{V} is valid, it returns temporary credentials, Cₜₘₚ to the data processing system 112. In some examples, rather than generating the temporary credentials, the temporary credentials are statically stored in the vault 620 such that the vault only needs to return the credentials associated with the vault token, T_{V}.

In a sixth step of the process (6), the data processing system attempts to access the Oracle/DB2 database 622 on behalf of the end user 106 by sending temporary credentials, Cₜₘₚ to the database.

In the seventh step of the process (7), the Oracle/DB2 database 622 verifies the temporary credentials, Cₜₘₚ by sending the credentials to the vault 620. If the vault 620 determines that that the temporary credentials are valid, it sends a message back to the Oracle/DB2 database 622 indicating that the end user is authorized to access the database.

### 5 Authorization Gateway

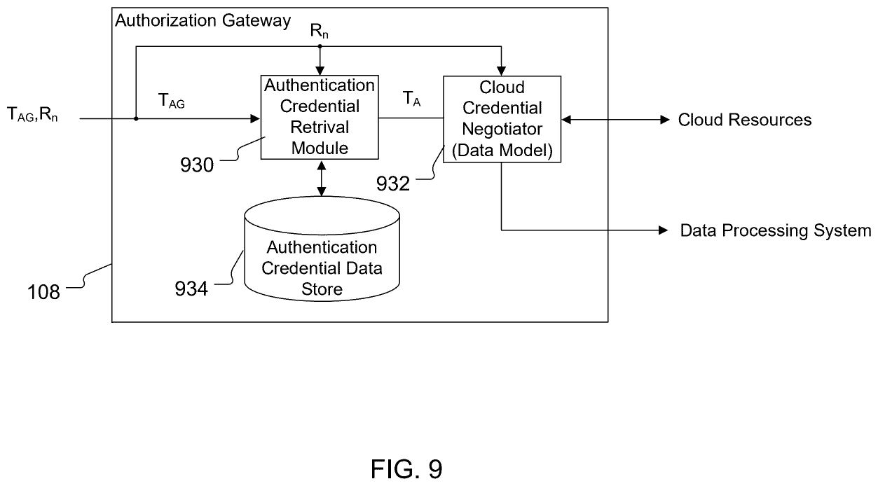

Referring to FIG. 9, in one example, the Authorization Gateway 108 includes an authorization credential retrieval module 930 and a cloud credential negotiator 932. The Authorization Gateway 108 has an input for receiving an end user's Authorization Gateway token, T_{AG} (or another equivalent token such as an API token) and a resource identifier, Rₙ for a resource that the end user intends to access using the data processing system. The Authorization Gateway 108 negotiates with the cloud resources to obtain credentials (e.g., temporary credentials) that are provided to the data processing system for accessing the resource.

In one example, the end user's Authorization Gateway token, T_{AG} and the resource identifier, Rₙ are first provided to the authorization credential retrieval module 930, which retrieves an authorization token, T_{A} (e.g., a previously obtained OAuth token) associated with the resource for the end user from an authorization credential data store 934. The cloud credential negotiator 932 then interacts with the resource using the authorization token, T_{A} to obtain credentials that the data processing system can use to access the resource. Different resources often require different steps to obtain credentials. For example, the Authorization Gateway 108 may need to interact with a cloud security token service and/or a broker to obtain the credentials. The cloud credential negotiator 932 includes a data model that specifies the sequence of steps that are required to obtain credentials for a given type of cloud resource (and possibly addresses of services such as security token services).

Once the cloud credential negotiator 932 obtains the credentials for the end user to access the resource, the credentials are provided to the data processing system.

### 6 Alternatives

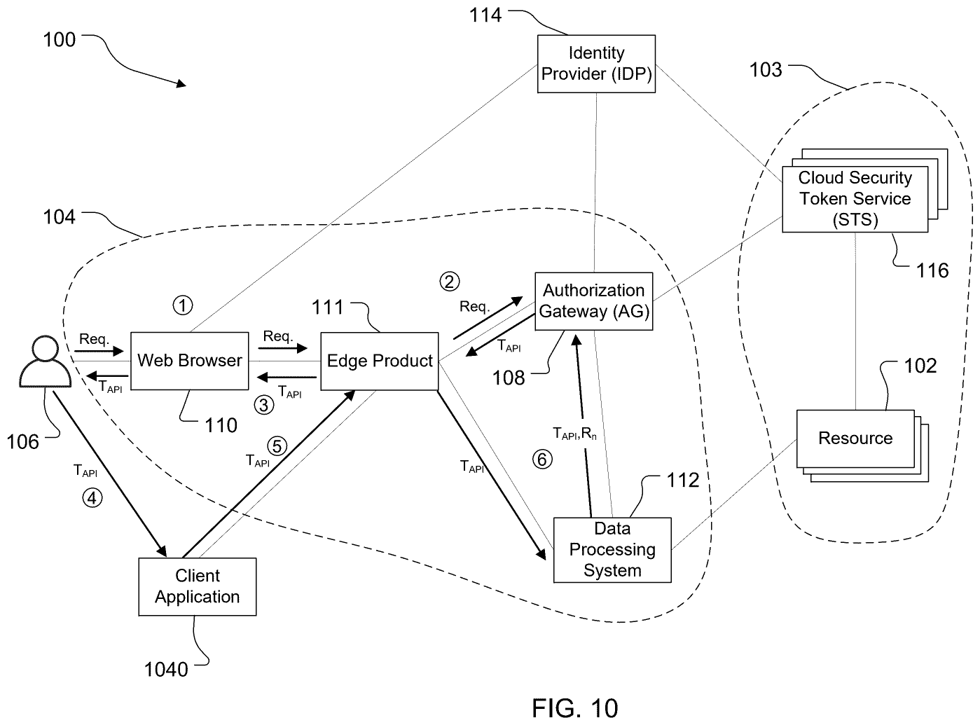

Referring to FIG. 10, in some examples, the heterogeneous cloud computing system 100 includes a client application 1040 (e.g., a Jupyter notebook, Python script, or other third-party application, or even a native Ab Initio application that is not accessible via the web browser 110) that requires programmatic access to cloud resources 102 on behalf of the authenticated end user 106. Similar to the local authorization process described in FIG. 2, FIG. 10 illustrates how API tokens are generated and managed to enable client applications to access the system's resources while maintaining the security and traceability benefits of individual user authentication.

In one example, API token generation and authorization for third-party applications is accomplished through a six-step process (i.e., steps (1)-(6)) that leverages the existing Authorization Gateway infrastructure. The process begins when the end user 106 has already been authenticated with the edge product 111 through the standard login process (as described in FIG. 2), establishing their session and obtaining an Authorization Gateway token, T_{AG}.

To enable third-party application access, in the first step of the process (1), the authenticated end user 106 requests an API token from the edge product 111 through the web browser 110. In the second step of the process (2), the edge product 111 communicates with the Authorization Gateway 108 to generate a unique API token, T_{API}, that is bound to the end user's existing Authorization Gateway token, T_{AG}. This binding ensures that the API token inherits the same permissions and access rights as the authenticated user's session.

In the third step of the process (3), the API token, T_{API}, is provided back to the end user 106 through the web browser 110, typically displayed as a text string that the user can copy to their clipboard. In a fourth step of the process (4), the end user 106 manually configures the client application 1040 by pasting or entering the API token into the application's configuration settings, authentication parameters, or initialization code. For example, in a Jupyter notebook environment, the end user might set the API token as an environment variable or pass it as a parameter when establishing a connection to the system. Once configured with the API token, T_{API}, the client application 1040 uses this token to authenticate directly with the edge product 111, effectively acting as a proxy for the authenticated end user 106.

In the fifth step of the process (5), when the client application 1040 makes requests to access cloud resources 102, it presents the API token, T_{API}, to the edge product 111. In the sixth step of the process (6), the edge product 111 provides the API token to the data processing system 112, which in turn sends the token to the AG along with a resource identifier, Rₙ to the authorization gateway 108. The authorization gateway 108 maps the API token back to the associated Authorization Gateway token, T_{AG}, ensuring that all resource access requests are processed with the appropriate user-specific permissions and credentials.

Importantly, the API token, T_{API}, shares the same lifecycle as the end user's session. When the end user's session expires or is terminated, the API token automatically becomes invalid, preventing unauthorized access by third-party applications after the user has logged out. This session-bound expiration mechanism ensures that API access cannot persist beyond the user's authenticated session, maintaining security while providing the flexibility needed for programmatic access.

The Authorization Gateway 108 treats requests originating from the client application 1040 (via the API token) substantially identically to requests originating from the web browser 110 (via the Authorization Gateway token). This unified approach ensures that the same credential negotiation processes, temporary credential generation, and resource access patterns described in the previous figures apply equally to both interactive and programmatic access scenarios.

This API token-based approach advantageously enables third-party applications and programmatic tools to access cloud resources 102 while preserving the individual user identity and permissions model that eliminates the need for service accounts. The system maintains full traceability and auditability of all resource access, whether initiated through the web browser interface or through third-party applications using API tokens.

In some examples, the client application 1040 may interact directly with the data processing system 112 rather than communicating through the edge product 111. In such configurations, the client application 1040 presents the API token, T_{API}, directly to the data processing system 112, which then validates the token with the Authorization Gateway 108 to confirm the associated user permissions and obtain the necessary credentials for accessing cloud resources 102. This direct interaction model may be advantageous for certain types of programmatic workloads that require more immediate access to data processing capabilities without the additional abstraction layer provided by the edge product 111.

The Authorization Gateway described above is compatible with other authorization schemes (e.g., username/password authorization schemes) and it should be understood that the operation of the authorization getaway is not limited to the authorization schemes described in the examples above and is not restricted to accessing cloud resources but also can be used to access on-premises resources and/or a combination of cloud resources and on-premises resources.

The examples described above refer to the end user as a single user, but it should be noted that groups of users all with the same permissions could be treated as one end user by the Authorization Gateway.

It is noted that, in some embodiments of the systems described herein, the edge product is an optional element.

### 7 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

In some examples, the Authorization Gateway 108 maintains an in-memory hash table data structure that maps Authorization Gateway tokens (T_{AG}) to corresponding user credential objects. Each credential object contains pointers to cached OAuth tokens, vault tokens, and temporary credentials, organized in a tree structure indexed by resource identifiers. This data structure enables efficient lookup time for credential retrieval while maintaining memory efficiency through automatic garbage collection of expired tokens. In some examples, the system implements a least-recently-used (LRU) cache eviction policy to manage memory consumption when the credential cache approaches predetermined size limits.

In some examples, the cloud credential negotiator 932 implements a connection pooling mechanism that maintains persistent HTTP/HTTPS connections to frequently accessed cloud security token services and identity providers. This reduces network latency by eliminating the overhead of establishing new SSL/TLS handshakes for each authentication request. The system dynamically adjusts connection pool sizes based on observed request patterns, with separate pools maintained for different authentication protocols (OAuth 2.0, SAML 2.0, proprietary APIs). Network requests are queued and batched where possible to minimize round-trip delays, particularly for bulk credential refresh operations.

In some examples, the Authorization Gateway employs asynchronous processing techniques to handle multiple credential negotiation requests concurrently without blocking system operations. A thread pool executor manages background tasks for token refresh operations, while the main processing thread continues handling new requests. The system implements non-blocking I/O operations when communicating with external identity providers, using callback mechanisms to process responses without thread blocking. This architecture enables the system to maintain responsiveness even when individual cloud platforms experience high latency.

In some examples, to enhance both security and performance, the system implements secure token storage using hardware security modules (HSMs) or software-based key derivation functions to encrypt cached credentials at rest. The encryption keys are rotated based on configurable time intervals, with seamless key transitions that do not interrupt ongoing operations. Additionally, the system maintains separate computational threads for cryptographic operations to prevent blocking of the main credential negotiation workflow, utilizing vectorized processing instructions where available to accelerate encryption and decryption operations.

Cloud platforms as described herein can be categorized by their technical authentication architectures. Type A platforms are OAuth-based with direct STS interaction (technical characteristics: stateless token validation, RESTful API endpoints, JSON Web Token format). Type B platforms are broker-mediated authentication requiring intermediate token exchange (technical characteristics: multi-stage authentication pipeline, proprietary token formats, stateful session management). Type C platforms are direct credential mapping systems (technical characteristics: embedded identity stores, native token translation, synchronous authentication validation)

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

What is claimed is:

1. A method for managing credentials in a heterogeneous cloud computing system, the method comprising:
receiving, at a local computing system, a request to access a cloud resource on behalf of an end user, the request including a unique identifier associated with the end user and a resource identifier associated with the cloud resource;
identifying, using the resource identifier, a predefined procedure for obtaining credentials for accessing the cloud resource;
performing the predefined procedure to obtain the credentials for accessing the cloud resource; and
accessing the cloud resource on behalf of the end user using the credentials.

2. The method of claim 1, wherein the unique identifier associated with the end user comprises an Authorization Gateway token that is bound to the end user for a current session.

3. The method of claim 1, wherein performing the predefined procedure comprises:
providing an authorization credential associated with the end user to a security token service associated with the cloud resource; and
receiving temporary credentials from the security token service.

4. The method of claim 3, wherein the authorization credential comprises an OAuth token or a SAML token.

5. The method of claim 1, wherein performing the predefined procedure comprises:
providing an authorization credential associated with the end user to a broker associated with the cloud resource to obtain an intermediate token; and
providing the intermediate token to a security token service associated with the cloud resource to obtain the credentials.

6. The method of claim 5, wherein the cloud resource is hosted on Microsoft Azure and the broker is an Azure broker.

7. The method of claim 1, wherein performing the predefined procedure comprises providing an authorization credential associated with the end user directly to the cloud resource to obtain access credentials.

8. The method of claim 7, wherein the cloud resource is a Snowflake database and the access credentials comprise a Snowflake-specific access token.

9. The method of claim 1, wherein performing the predefined procedure comprises:
providing a vault token associated with the end user to a vault; and
receiving the credentials from the vault.

10. The method of claim 9, wherein the credentials comprise a username and password pair for accessing an on-premises database.

11. The method of claim 1, further comprising:
authenticating the end user with the local computing system; and
obtaining and storing an authorization token for the end user based on the authentication.

12. The method of claim 1, further comprising:
generating an API token associated with the end user in response to a request from the end user;
providing the API token to the end user for configuration in a client application; and
receiving subsequent requests to access cloud resources from the client application using the API token.

13. The method of claim 12, wherein the API token expires when the end user's session expires.

14. The method of claim 12, wherein the client application comprises a Jupyter notebook, Python script, or other third-party application.

15. The method of claim 1, wherein the heterogeneous cloud computing system comprises cloud resources hosted on a plurality of different cloud platforms including at least two of Amazon Web Services, Microsoft Azure, Google Cloud Platform, IBM Cloud, and Oracle Cloud.

16. The method of claim 1, wherein the credentials obtained for the end user provide access to the cloud resource with permissions that are specific to the end user and different from permissions that would be provided by a service identity.

17. A system for managing credentials in a heterogeneous cloud computing system, the system comprising:
an Authorization Gateway comprising:
an authorization credential retrieval module configured to retrieve authorization credentials associated with an end user; and
a cloud credential negotiator configured to interact with cloud resources to obtain temporary credentials for the end user;
wherein the Authorization Gateway is configured to:
receive a request to access a cloud resource on behalf of the end user, the request including a unique identifier associated with the end user and a resource identifier associated with the cloud resource;
identify, using the resource identifier, a predefined procedure for obtaining credentials for accessing the cloud resource;
perform the predefined procedure to obtain the credentials for accessing the cloud resource; and
provide the credentials to a data processing system for accessing the cloud resource on behalf of the end user.

18. The system of claim 17, wherein the cloud credential negotiator comprises a data model that specifies a sequence of steps required to obtain credentials for different types of cloud resources.

19. A non-transitory computer-readable medium storing instructions that, when executed by a processor, cause the processor to perform a method for managing credentials in a heterogeneous cloud computing system, the method comprising:
receiving, at a local computing system, a request to access a cloud resource on behalf of an end user, the request including a unique identifier associated with the end user and a resource identifier associated with the cloud resource;
identifying, using the resource identifier, a predefined procedure for obtaining credentials for accessing the cloud resource;
performing the predefined procedure to obtain the credentials for accessing the cloud resource; and
accessing the cloud resource on behalf of the end user using the credentials.

20. A system for managing credentials in a heterogeneous cloud computing environment, comprising:
means for receiving a request to access a cloud resource on behalf of an end user, the request including a unique identifier associated with the end user and a resource identifier associated with the cloud resource;
means for identifying, based on the resource identifier, a predefined procedure for obtaining credentials for accessing the cloud resource;
means for performing the predefined procedure to obtain the credentials for accessing the cloud resource; and
means for accessing the cloud resource on behalf of the end user using the credentials.
